(19) United States
(12) Patent Application Publication
(10) Pub. No.: US 2014/0284348 A1
(43) Pub. Date: Sep. 25, 2014

(54) MEDICINE PACKET DISPENSING DEVICE WITH AUTOMATIC REMINDER FUNCTION

(71) Applicant: TZU CHI UNIVERSITY, HUALIEN COUNTY (TW)

(72) Inventor: JEN-LIANG CHENG, HUALIEN COUNTY (TW)

(73) Assignee: TZU CHI UNIVERSITY, HUALIEN COUNTY (TW)

(21) Appl. No.: 14/196,471

(22) Filed: Mar. 4, 2014

(30) Foreign Application Priority Data
Mar. 22, 2013 (TW) 102205349

(51) Int. Cl. A61J 7/04; G06F 19/00

(52) U.S. Cl. CPC A61J 7/04; G06F 19/3462
USPC 221/3; 221/2

(57) ABSTRACT

A medicine packet dispensing device with an automatic reminder function comprises a box having a medicine discharge hole; a control device arranged in the box; and a medicine discharge module arranged in the box. The control device includes a processor used to set at least one medication time; at least one reminder unit controlled by the control device to emit an alert according to the medication time; and a plurality of medicine discharge operating interfaces used to input an instruction to the processor to enable the processor to generate a medicine discharge signal to the medicine discharge module. The medicine discharge module has medicine packet accommodation spaces for accommodating medicine packets and sends one medicine packet to the medicine discharge hole according to the medicine discharge signal. The present invention reminds the user to take medicine at designated times and allows the user to change the medication times.

This application claims priority for Taiwan patent application no. 102205349 filed at Mar. 22, 2013, the content of which is incorporated by reference in its entirely.

### BACKGROUND OF THE INVENTION

1. Field of the Invention

The present invention relates to a medicine dispensing device, particularly to a medicine packet dispensing device with an automatic reminder function, which can automatically remind the user to take medicine at designated times.

2. Description of the Related Art

Taking medicine is a routine for patients of chronic diseases. Owing to poor memory or personal willingness, some patients may forget to take medicine, omit a portion of medicine, or arbitrarily increase the dosage of medicine, which will degrade the medicine effectiveness or result in medicine abuse. Therefore, the fields concerned have persistently proposed various schemes to solve the problem.

There are various types of carry-about pill boxes available in the market for conveniencing the outgoing patients. The pill box contains a plurality of pill collection compartments each having a lid. The user may respectively place the pills, which will be taken each meal in the following several days, into the medicine collection compartments. In some pill boxes, the times of taking medicines are also shown on the lids of the pill collection compartments, such as breakfast, lunch, dinner and bedtime, whereby the user can easily recognize the medicines for different medication times. The conventional pill boxes are indeed helpful to users. However, if the user cannot remember whether he has taken medicine at a specified time, he may take the medicine repeatedly, risking his health.

Besides, the pill collection compartments listing the times of taking medicines are unlikely to receive powdered medicine and hard to clean. If the user intends to clean the pill collection compartments, he has to reach his finger into the pill collection compartments, which may pollute the pill collection compartments or even affect the health of the user.

Accordingly, the present invention proposes a medicine packet dispensing device with an automatic reminder function to overcome the conventional problems mentioned above.

### SUMMARY OF THE INVENTION

The primary objective of the present invention is to provide a medicine packet dispensing device with an automatic reminder function, wherein the medicine packets are disposed in the dispensing device, and wherein the medication times are set in the dispensing device to remind the user of taking medicine, and wherein the dispensing device only discharge only one medicine packet containing a proper dose each time, whereby the user will not take medicine wrongly or repeatedly.

Another objective of the present invention is to provide a medicine packet dispensing device with an automatic reminder function, wherein the medication times can be adjusted to convenience the user.

A further objective of the present invention is to provide a medicine packet dispensing device with an automatic reminder function, which can stores the medication record of the user, whereby the medical personnel can check whether the user takes medicine at designated times.

To achieve the abovementioned objectives, the present invention proposes a medicine packet dispensing device with an automatic reminder function, which comprises a box having a medicine discharge hole; a control device arranged in the box; and a medicine discharge module arranged in the box and controlled by the control device. The control device includes a processor used to set at least one medication times; at least one reminder unit controlled by the processor according to the medication times to emit an alert to remind the user to take medicine; and a plurality of medicine discharge operating interfaces. The user uses the medicine discharge operating interfaces to select and input an instruction to the processor. The processor generates a medicine discharge signal to the medicine discharge module according to the instruction. The medicine discharge module is electrically or mechanically connected with the processor and has a plurality of medicine packet accommodation spaces to accommodate medicine packets. The medicine discharge module sends a medicine packet from one medicine packet accommodation space to the medicine discharge hole according to the medicine discharge signal output by the processor. Then, the medicine packet is released into the medicine discharge hole.

Below, the embodiments are described in detail in cooperation with the drawings to further demonstrate the characteristics and accomplishments of the present invention.

### BRIEF DESCRIPTION OF THE DRAWINGS

FIG. 1 is a perspective view schematically showing a medicine packet dispensing device with an automatic reminder function according to one embodiment of the present invention;

FIG. 2 is a diagram schematically showing the interior structure of a medicine packet dispensing device with an automatic reminder function according to one embodiment of the present invention;

FIG. 3 is a block diagram schematically showing a control device and a medicine discharge module of a medicine packet dispensing device with an automatic reminder function according to one embodiment of the present invention; and

FIG. 4 is a diagram schematically showing the operation of a medicine packet dispensing device with an automatic reminder function according to one embodiment of the present invention.

### DETAILED DESCRIPTION OF THE INVENTION

In the present invention, the medicine packets each containing a proper dose of medicine prepared by the hospital are charged into the medicine packet dispensing device; the medicine packet dispensing device only discharges the very medicine packet containing the medicine prescribed for the current medication at each medication time lest the user takes wrong medicine. Further, the present invention reminds the user to take medicine at the designated medication times. Furthermore, the present invention has a mechanism allowing the user to advance or delay medication.

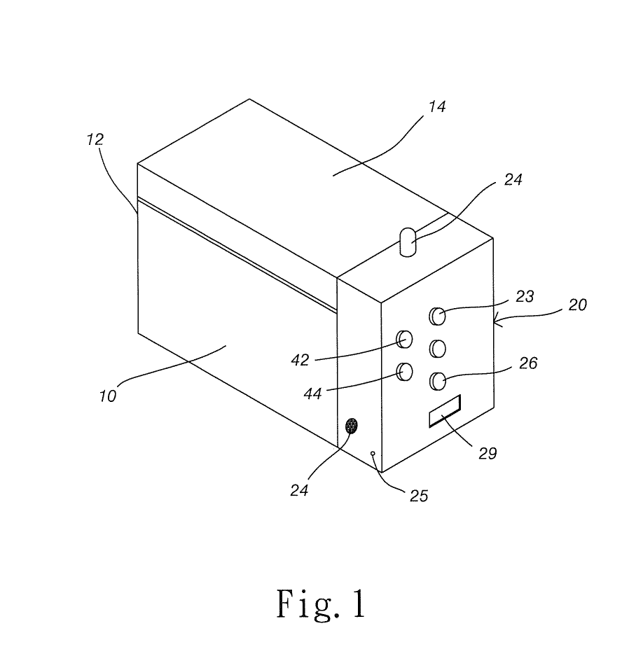

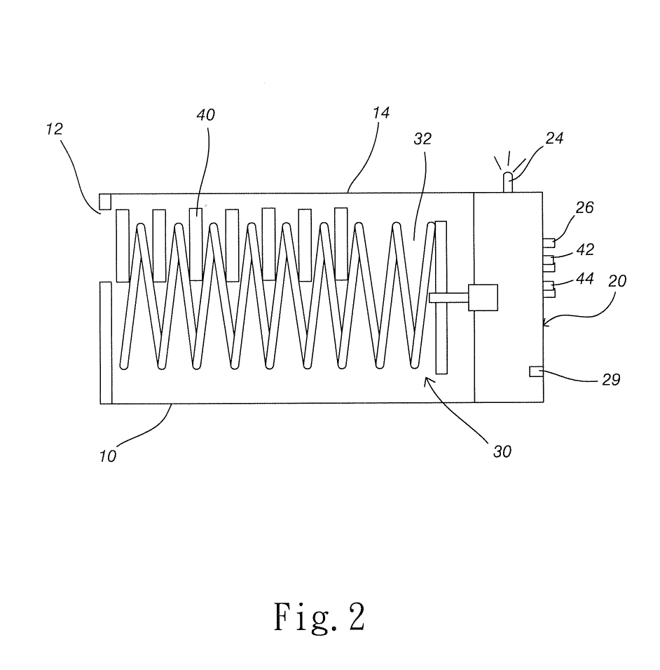

Refer to FIG. 1 and FIG. 2. In one embodiment, the medicine packet dispensing device with an automatic reminder function of the present invention comprises a box 10 having a medicine discharge hole 12; a control device 20 arranged in the box 10; a medicine discharge module 30 arranged in the box 10 and controlled by the control device 20. The medicine discharge module 30 has at least one medicine packet accommodation space 32 to accommodate medicine packets 40. A medicine charge window 14 is arranged on the box 10 and corresponding to the medicine discharge module 30. The user opens the medicine charge window 14 to charge the medicine packets 40 into the medicine packet accommodation spaces 32. When it is the medication time, the control device 20 sends a signal to the medicine discharge module 30, and the medicine discharge module 30 discharges one medicine packet 40. In one embodiment, the medicine discharge module 30 contains a screw shaft. The screw shaft drives the medicine packets 40 accommodated in the medicine packet accommodation spaces 32 to move toward the medicine discharge hole 12. Then, the medicine packet 40 is released into the medicine discharge hole 12. In one embodiment, the medicine discharge module 30 contains a tumbler, and the medicine packets 40 are wound around the tumbler. According to the medicine discharge signal, the tumbler is rotated to discharge one medicine packet 40. In one embodiment, the medicine discharge module 30 contains a pushrod. According to the medicine discharge signal, the pushrod pushes out one medicine packet 40 each time. The mechanisms of the medicine discharge module 30 can securely discharge medicine having a proper dose at designated times. Thus, users are unlikely to take wrong medicine. Therefore, the present invention can guarantee the safety of medication.

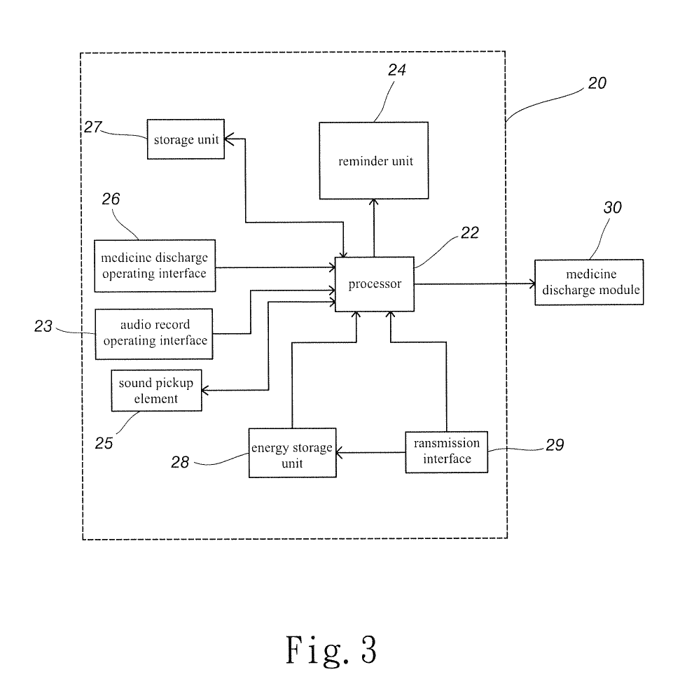

Next, the control device of the present invention is described in detail. Refer to FIG. 2 and FIG. 3. The control device 20 includes a processor 22 used to set at least one medication time. The medication times are set via a computer at a medical facility. The processor 22 is electrically connected with a transmission interface 29, such as a USB (Universal Serial Bus) port. The medical computer is electrically connected with the transmission interface 29 to sets the medication times into the processor 22 via the transmission interface 29. The control device 20 is a detachable device, which can be detached and then carried to the hospital where the medical computer is located. Then, the medical computer sets the medication times into the control device 20. According to the medication times, the processor 22 controls at least one reminder unit 24 to emit an alert to remind the user of taking medicine. The reminder unit 24 is an LED (Light Emitting Diode), a sound output element, or a display. The reminder unit 24 emits light or sounds to remind the user of taking medicine when it is time to take medicine. In one embodiment, the reminder units 24 includes an LED and a sound output element, respectively emitting light and sounds simultaneously to remind the user of taking medicine. In one embodiment, the control device 20 has an audio record operating interface 23 electrically connected with the processor 22 and used to input an instruction to the processor 22. According to the instruction, the processor 22 generates an audio recording signal to turn on a sound pickup element 25 electrically connected with the processor 22. Once turned on, the sound pickup element 25 begins to record voices. The processor 22 stores the brief medication reminding voices into a storage unit 27 electrically connected with the processor 22. When it is time to take medicine, the brief medication reminding voices are output to remind the user. The recorded voices may be the voices of the user so that the user is more willing to take medicine. The control device 20 also includes a plurality of medicine discharge operating interfaces 26 electrically connected with the processor 22. The user uses the medicine discharge operating interface 26 to input an instruction to the processor 22. The user may use tilt, movement, and/or vibration to operate the medicine discharge operating interface 26. According to the instruction, the processor 22 generates a medicine discharge signal to control the medicine discharge module 30. Then, the medicine discharge module 30 drives the medicine packet 40 to drop into the medicine discharge hole 12. In one embodiment, the control device 20 stores the medication times in the storage unit 27 according to the medicine discharge signals, whereby the medical personnel can review the medication times of the user on the medical computer, and transmission the recording medication activities to computer by transmission interface 29. In one embodiment, the control device 20 also includes an energy storage unit 28 electrically connected with the processor 22 and the transmission interface 29. The energy storage unit 28 is electrically charged via the transmission interface 29 by an external electric source and provides power for the internal components of the medicine packet dispensing device with an automatic reminder function.

Either a computer that connected to the dispenser or medicine discharge operating interfaces 26 can be used to set up to four time points for medication reminding. The latter comprises a selector button 42 and an adjuster button 44. Selector button 42 is used to select which one of the time point to be displayed and adjusted. By pushing the adjuster button 44, one can begin to adjust the time point selected. Once the adjustment is finished, one can push the adjusting button again to set up the time adjusted. A time point of value greater than 23:59 is treated as an invalid value and does not trigger the reminding function.

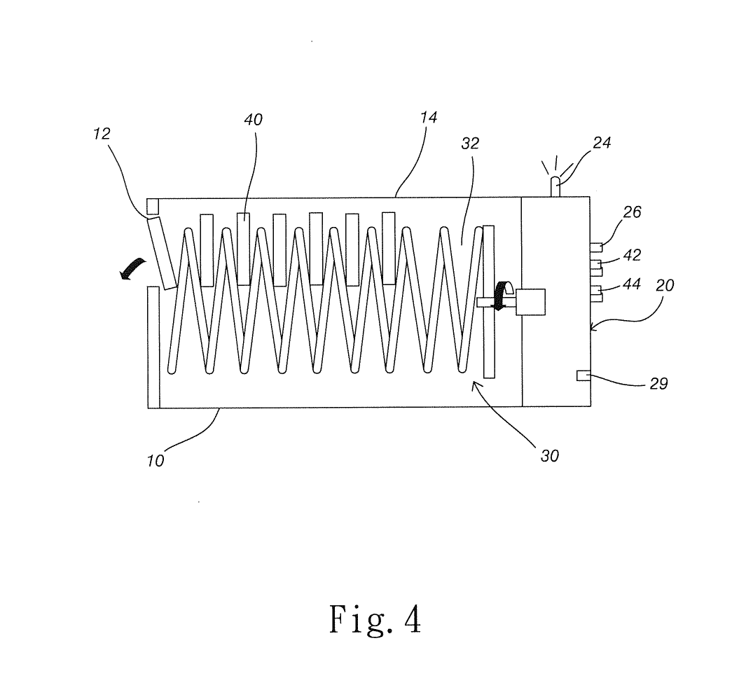

Next, the medicine discharge operating interfaces of the present invention is described in detail. Refer to FIG. 3 and FIG. 4. In one embodiment, the medicine discharge operating interface 26 contains a medicine discharge button and a discharge delaying button. If the user intends to take medicine in advance, he presses the medicine discharge button to send a medicine discharge instruction to the processor 22. According to the medicine discharge instruction, the processor 22 generates a medicine discharge signal to control the medicine discharge module 30 to operate. The screw shaft drives the medicine packets 40 to move along the axis thereof and finally discharges one medicine packet 40 into the medicine discharge hole 12. Then, the user receives the medicine packet 40 and takes the medicine in advance. In such a case, the processor 22 will not emit an alert to remind the user of taking medicine at the original designated medication time. Suppose that the user intends to take medicine routinely. At the designated medication time, the processor 22 controls the reminder unit 24 to emit an alert to remind the user of taking medicine. Thus, the user presses the medicine discharge button, and the processor 22 generates a medicine discharge signal to the medicine discharge module 30. Hence, the medicine discharge module 30 starts to operate, and the screw shaft drives the medicine packets 40 to move along the axis thereof and finally discharges one medicine packet 40 into the medicine discharge hole 12. Then, the user receives the medicine packet 40 and takes the medicine routinely. Suppose that the user intends to delay taking medicine. Once the time for medication is reached, the processor 22 controls the reminder unit 24 to emit an alert to remind the user that it is time for medication. The user presses the discharge delaying button. Thus, the processor 22 delays medicine discharge and remind the user of the new medication time or the time lag. In the abovementioned cases, the storage unit 27 records each medication activity of the user, whereby the medical personnel can check whether the user takes medicine on time.

In the present invention, the user directly places medicine packets in the medicine dispensing device, neither opening the medicine packets nor using his finger to take the medicine. Therefore, the present invention exempts medicine from pollution. The present invention reminds the user of taking medicine at designated times. The present invention only discharges one medicine packet having a proper dose each time lest the user takes medicine wrongly or repeatedly. In the present invention, the medication times can be adjusted to convenience the user. Further, the present invention stores the medication record of the user, whereby the medical personnel can check whether the user takes medicine at designated times.

The embodiments described above are only to exemplify the present invention but not to limit to the scope of the present invention. Any equivalent modification or variation according to the characteristic or spirit of the present invention is to be also included within the scope of the present invention.

What is claimed is:

1. A medicine packet dispensing device with an automatic reminder function, comprising
a box having a medicine discharge hole at one side thereof;
a control device arranged in said box and including
a processor used to set at least one medication time;
at least one reminder unit controlled by said control device and emitting an alert according to each one of said medication time; and
a plurality of medicine discharge operating interfaces used to input an instruction to said processor to enable said processor to generate a medicine discharge signal according to said instruction;
a medicine discharge module arranged in said box, electrically connected with said processor, having at least one medicine packet accommodation space for accommodating medicine packets, and sending one of said medicine packets to said medicine discharge hole according to said medicine discharge signal of said processor.

2. The medicine packet dispensing device with an automatic reminder function according to claim 1, wherein said control device further includes a transmission interface electrically connected with said processor, wherein a computer at a medical facility sets said medication time into said processor via said transmission interface.

3. The medicine packet dispensing device with an automatic reminder function according to claim 2, wherein said transmission interface is a USB (Universal Serial Bus) port.

4. The medicine packet dispensing device with an automatic reminder function according to claim 1, wherein said reminder unit is a light emitting diode.

5. The medicine packet dispensing device with an automatic reminder function according to claim 1, wherein said reminder unit is a sound output element.

6. The medicine packet dispensing device with an automatic reminder function according to claim 1, wherein said medicine discharge module contains a screw shaft.

7. The medicine packet dispensing device with an automatic reminder function according to claim 1, wherein said control device further includes a storage unit electrically connected with said processor and recording medication activities according to said medicine discharge signals, and transmission the recording medication activities to computer by transmission interface.

8. The medicine packet dispensing device with an automatic reminder function according to claim 2, wherein said control device further includes an energy storage unit electrically connected with said processor and said transmission interface and charged by an external power source via said transmission interface.

9. The medicine packet dispensing device with an automatic reminder function according to claim 1, wherein said medicine discharge operating interface contains a medicine discharge button and a discharge delaying button.

10. The medicine packet dispensing device with an automatic reminder function according to claim 1, wherein a medicine charge window is arranged above said medicine discharge module, and wherein a user opens said medicine charge window to charge said medicine packets into said medicine packet accommodation spaces.

11. The medicine packet dispensing device with an automatic reminder function according to claim 7, wherein said control device further includes an audio record operating interface and a sound pickup element, and wherein said audio record operating interface and said sound pickup element are electrically connected with said processor, and wherein an instruction is input to said processor via said audio record operating interface, and wherein according to said instruction, said processor generates an audio recording signal to turn on said sound pickup element to pick up audio signals and store said audio signals in said storage unit.

12. The medicine packet dispensing device with an automatic reminder function according to claim 1, wherein said processor set least four medication time points, and said medicine discharge operating interfaces comprising a selector button and an adjuster button, said selector button select one of section medication time, and use said adjuster button to adjuster the time of said section medication time.
